(19) United States
(12) Patent Application Publication
(10) Pub. No.: US 2019/0233252 A1
(43) Pub. Date: Aug. 1, 2019

(54) ELEVATOR ACCESS SYSTEMS FOR ELEVATORS

(71) Applicant: Otis Elevator Company, Farmington, CT (US)

(72) Inventors: Nicolas Philippe, Sully sur Loire (FR); Guillaume Paul, Ouzouer sur Trezee (FR)

(21) Appl. No.: 16/257,352

(22) Filed: Jan. 25, 2019

(30) Foreign Application Priority Data
Jan. 29, 2018 (EP) 18305078.0

(51) Int. Cl. B66B 5/00; B66B 11/00

(52) U.S. Cl. CPC B66B 5/0087; B66B 11/001

(57) ABSTRACT

Elevator component access cabinets are provided. The elevator component access cabinets include a housing having an access door, a sliding element contained within the housing, and at least one elevator component pivotably mounted to the sliding element about a first pivot. The sliding element is movable between a first state and a second state, and wherein when in the first state, the at least one elevator component is stowed within the housing and in the second state the at least one elevator component is located outside of the housing, and the at least one elevator component is pivotable about the first pivot to enable access to the at least one elevator component.

### BACKGROUND

The subject matter disclosed herein generally relates to elevator systems and, more particularly, to access systems and devices for access to elevator components for elevator maintenance.

Typically, elevator systems include machine rooms to house various elevator components (e.g., electronics, electrical systems, etc.). However, to save space, in some elevator systems no machine room is provided, or only certain components are housed in a machine room. To accommodate no machine room, or a smaller machine room, some conventional elevator maintenance apparatuses and devices are placed together inside a wall close to the entrance to an elevator, such as a cabinet. For the purpose of saving space, moreover, the space provided on the wall for accommodating these apparatuses and devices is not big. As a result, it is not convenient for operators to perform maintenance.

However, landing control cabinets allow easy maintenance without hoistway or elevator shaft access. Thus, consideration for space constraints, ease of access, safety, and aesthetic considerations are taken into account because this cabinet is visible to users. Accordingly, it is desirable to have a low profile cabinet that enables access to some elevator components. However, this constraint imposes components having restricted dimensions enabling them to be inserted into the landing cabinets.

### SUMMARY

According to some embodiments, elevator component access cabinets are provided. The elevator component access cabinets include a housing having an access door, a sliding element contained within the housing, and at least one elevator component pivotably mounted to the sliding element about a first pivot. The sliding element is movable between a first state and a second state, and wherein when in the first state, the at least one elevator component is stowed within the housing and in the second state the at least one elevator component is located outside of the housing, and the at least one elevator component is pivotable about the first pivot to enable access to the at least one elevator component.

In addition to one or more of the features described above, or as an alternative, further embodiments of the elevator component access cabinets may include that the housing has a length and a width, wherein the length is longer than the width.

In addition to one or more of the features described above, or as an alternative, further embodiments of the elevator component access cabinets may include that the length is at least twice as long as the width.

In addition to one or more of the features described above, or as an alternative, further embodiments of the elevator component access cabinets may include that the access door is pivotably mounted to the housing by a second pivot.

In addition to one or more of the features described above, or as an alternative, further embodiments of the elevator component access cabinets may include a lock arranged to secure the access door to the housing when the sliding element is in the first state.

In addition to one or more of the features described above, or as an alternative, further embodiments of the elevator component access cabinets may include that the at least one elevator component comprises at least one of an elevator control board, a fuse, a breaker, a plug, an inspection panel, a battery, a transformer, an electrical distribution panel, and wiring.

According to some embodiments, elevator systems are provided that incorporate the elevator component access cabinets of any embodiments described herein.

In addition to one or more of the features described above, or as an alternative, further embodiments of the elevator systems may include the elevator component access cabinet is part of an elevator door column.

In addition to one or more of the features described above, or as an alternative, further embodiments of the elevator systems may include a landing having a landing door, wherein the elevator component access cabinet is located adjacent the landing door.

In addition to one or more of the features described above, or as an alternative, further embodiments of the elevator systems may include that at least one of the housing and the access door are an aesthetic feature of the elevator system.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2 is a schematic illustration of a landing floor of an elevator system with a hall call panel that may employ various embodiments of the present disclosure;

FIG. 3A illustrates an elevator component access cabinet in accordance with an embodiment of the present disclosure in a first state;

FIG. 3B illustrates the elevator component access cabinet of FIG. 3A, in a first intermediate state;

FIG. 3C illustrates the elevator component access cabinet of FIG. 3A, in a second intermediate state;

FIG. 3D illustrates the elevator component access cabinet of FIG. 3A, in a second state; and

FIG. 4 is a schematic illustration an elevator component access cabinet in accordance with an embodiment of the present disclosure.

### DETAILED DESCRIPTION

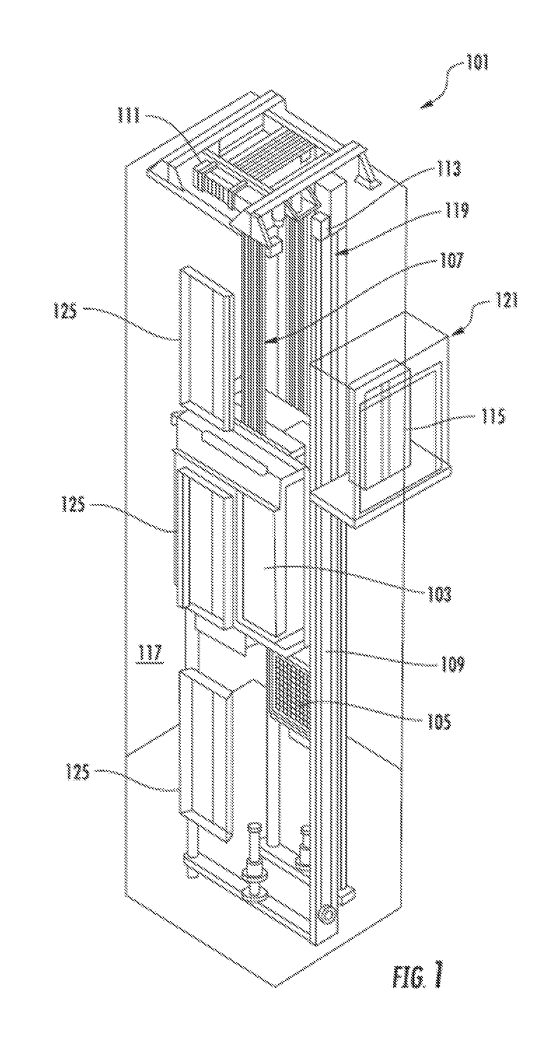

FIG. 1 is a perspective view of an elevator system 101 including an elevator car 103, a counterweight 105, a roping 107, a guide rail 109, a machine 111, a position encoder 113, and an elevator controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which, in this illustrative embodiment, is part of an overhead structure of the elevator system 101, although other arrangements are possible without departing from the scope of the present disclosure. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The elevator controller 115 is located, as shown in the illustrative arrangement, in a controller room 121 of the elevator shaft 117 and is configured to control the operation of the elevator system 101, and particularly the elevator car 103. In other embodiments the elevator controller 115 can be located in other locations, including, but not limited to, fixed to a landing or landing door or located in a cabinet at a landing. The elevator controller 115 may provide drive signals to the machine 111 to control the acceleration, deceleration, leveling, stopping, etc. of the elevator car 103. The elevator controller 115 may also be configured to receive position signals from the position encoder 113. When moving up or down within the elevator shaft 117 along guide rail 109, the elevator car 103 may stop at one or more landings 125 as controlled by the elevator controller 115. As noted, those of skill in the art will appreciate that the elevator controller 115 or other control elements of the elevator system can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

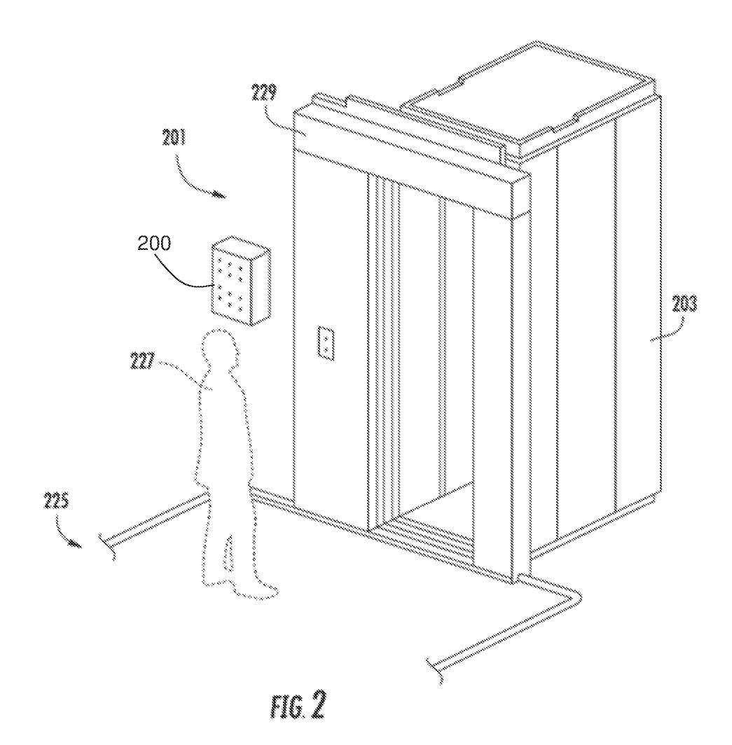

FIG. 2 is a schematic illustration of an elevator system 201 that may incorporate embodiments disclosed herein. As shown in FIG. 2, an elevator car 203 is located at a landing 225. The elevator car 203 may be called to the landing 225 by a passenger or mechanic 227 that desires to travel to another floor within a building or perform maintenance on a portion of the elevator system 201. In some situations, the mechanic 227 may wish to lock a feature of the elevator system, e.g., the elevator doors, an elevator trap, etc., such that the feature(s) cannot be opened or closed (e.g., to prevent unauthorized persons from accessing the elevator system 201 or portions thereof). For example, such situation may arise when the mechanic 227 wishes to access the elevator car and/or shaft to perform maintenance. Such control or locking can be achieved by a lock in a landing door lintel 229 of the elevator system 201 (which may be located at one or more landings 225). It may be advantageous to prevent unauthorized persons from accessing the lock and also enable access in a controlled manner.

For example, in some configurations, an access cabinet 200 (e.g., an emergency and inspection cabinet) can be located at one or more landings 225 of the elevator system. The access cabinet 200 can include one or more electrical and/or mechanical components that are configured to enable operation, control of, and/or access to an associated elevator system. For example, the access cabinet 200 can include a specialized or unique access key or tool (“access device”) for a mechanic or other authorized person to lock and unlock various locks of the elevator system (e.g., lintel door locks, etc.). The access cabinet 200 can further include various components or elements of the elevator system, such as various electrical components.

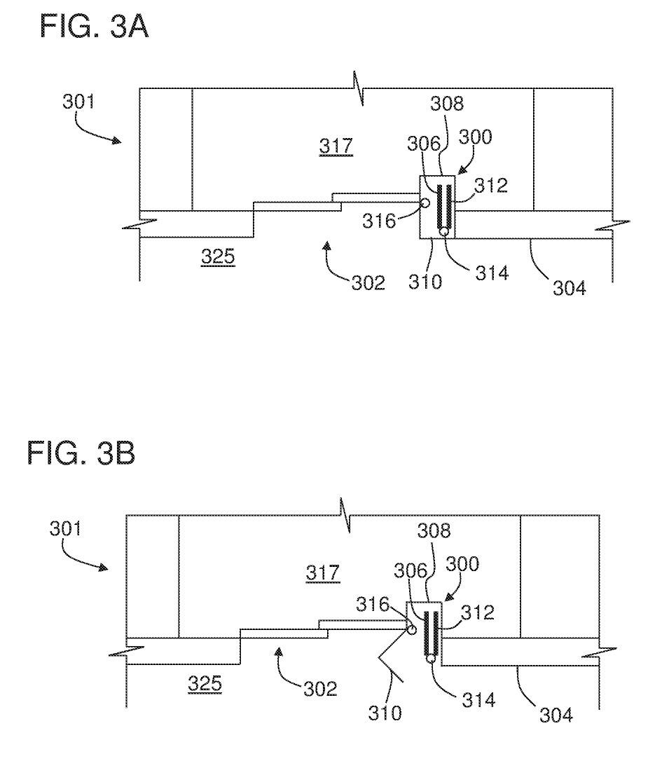

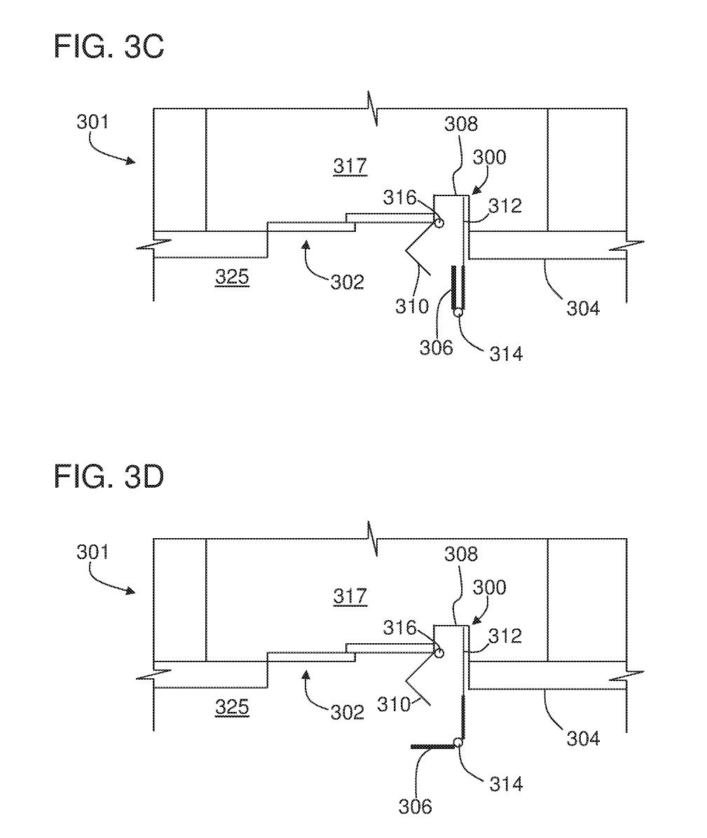

Turning now to FIGS. 3A-3D, schematic illustrations of an access cabinet 300 in accordance with a non-limiting embodiment of the present disclosure are shown. The access cabinet 300 is part of an elevator system 301 that includes an elevator shaft 317, a landing 325, and landing doors 302 located at the landing 325. The landing doors 302 enable a passenger or other person to enter and exit an elevator car when the elevator car is located at the landing 325. The elevator system 301 can include a plurality of landings similar to that shown in FIG. 3A. The access cabinet 300 is located on a wall 304 adjacent the landing doors 302 and contains elevator components 306 therein. As such, the access cabinet 300 includes a housing 308 and an access door 310 that is openable by a mechanic to enable access to the elevator components 306. The elevator components 306 can include, without limitation, elevator control boards, fuses, breakers, plugs, inspection panels, batteries, transformers, electrical distribution panels, and/or input/output wiring (e.g., electrical, communication, etc.).

The elevator components 306 are pivotably mounted upon a sliding element 312. The sliding element 312 enables the elevator components 306 to slide out of the housing 308 to allow access thereto and to slide into the housing 308 for storage and normal operation. The elevator components 306 are mounted to the sliding element 312 by a first pivot 314. The first pivot 314 allows for a mechanic or other person to rotate the elevator components 306 from a first position to a second position, in order to perform inspections, maintenance, etc.

Further, the access door 310 of the housing 308 is optionally mounted to the housing 308 by a second pivot 316. The second pivot 316 enables a mechanic or other person to open the access door 310 in a pivoting manner. However, in other embodiments, the access door 310 may be a removable panel, sliding panel (e.g., slide up or down), etc. as will be appreciated by those of skill in the art. The access door 310 may be a lockable or secured door or panel that is arranged to prevent unauthorized access thereto.

FIG. 3A illustrates the access cabinet 300 in a first or stowed state. The first state is a state in which the access door 310 is closed and access to the elevator components 306 is prevented. The first state is a normal operation mode for the elevator system 301, wherein passengers can actively call and move within a building using an elevator car of the elevator system 301.

FIG. 3B illustrates a first intermediate state of the access cabinet 300. In the first intermediate state, the access door 310 has been opened, enabling access to the elevator components 306. In this illustrative embodiment, the access door 310 is unlocked and then pivoted about the second pivot 316. However, because of the dimensions of the housing 308, direct or easy access to the elevator components 306 may not be possible. However, in this state, a user can use the sliding element 312 to enable removal of the elevator components 306 from the housing 308.

FIG. 3C illustrates a second intermediate state of the access cabinet 300. In the second intermediate state, the access door 310 remains open and the sliding element 312 has extended from a stowed state to an extended state. In the extended state of the sliding element 312, the elevator components 306 have been removed from the housing 308.

FIG. 3D illustrates the access cabinet 300 in a second state. In the second state, a technician, mechanic, or other authorized person may have access to the elevator components to perform inspections, repair, replacement, or other maintenance tasks associated with the elevator components 306. As shown, the elevator components 306 are pivoted from the sliding element 312 about the first pivot 314. In this position, a mechanic will have easy access to the elevator components 306.

After a maintenance operation is performed, the user (e.g., mechanic, technician, etc.) can rotate or fold the elevator components 306 back along the sliding element 312. The sliding element 312, along with the attached elevator components 306, can then be slid back into the housing 308 to stow the elevator components 306 into the housing 308. The access door 310 can then be closed and locked.

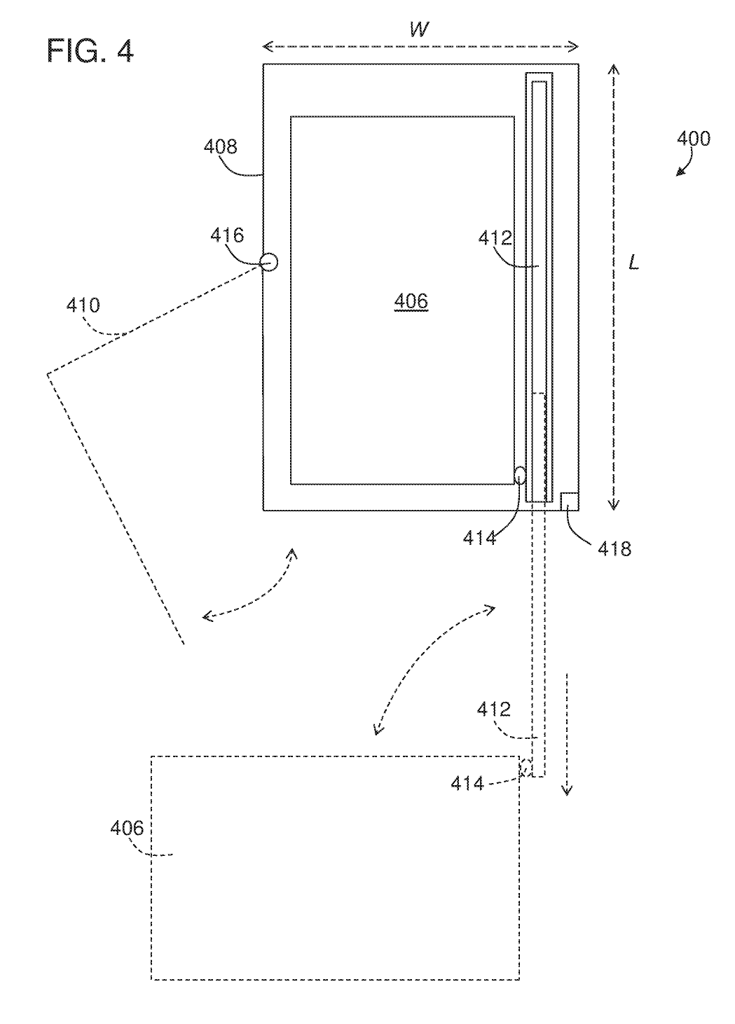

Turning now to FIG. 4, a schematic illustration of an access cabinet 400 in accordance with the present disclosure is shown. In FIG. 4, the solid line representation illustrates the access cabinet 400 in a first (closed or stowed) state and the dashed lines illustrate a second (open or extended) state of the access cabinet 400.

As shown, the access cabinet 400 includes a housing 408 with an access door 410. The access door 410 is openable, shown pivoting about a second pivot 416. Within the housing 408 is a sliding element 412 to which elevator components 406 are pivotably mounted on a first pivot 414. As shown, the access door 410 is lockable using a lock 418 that can be secured to prevent access to the elevator components 406 when in the first state.

As shown, the housing 408 has a width W and a length L. Advantageously, embodiments of the present disclosure enable a more discrete and minimized dimensions that face a landing, while allowing for storing and stowing an increased size and/or number of components within the housing 408. As shown, the length L is greater than the width W of the housing 408. In some embodiments, the length L is at least twice as long in dimension as compared to the width W, although other dimensional relationships are possible without departing from the scope of the present disclosure. The increased length L allows for the increased space to allow for larger or more elevator components 406 to be stored within the access cabinet 400.

The housing 408, and the access door 410, are located at a landing, as noted above, and form a visible or aesthetic feature of the elevator system (e.g., panel, facing, or facade) that is visible to persons located at the landing. However, because the width W is minimized (e.g., smaller or shorter than the length L), the visible portions of the access cabinet 400 may be minimized to prevent unnecessary impact on the visual appearance at the landing. Moreover, because of the relatively small width W, the access cabinet 400 can be installed in or part of an elevator door column that frames and supports a landing door of the elevator system. Accordingly, integration into existing systems, without increased space or size requirements is achievable.

Advantageously, embodiments provided herein provide for elevator system access cabinets that provide minimal visible or aesthetic impact at a landing while allowing for little to no reduction in the number or size of elevator components that can be stored within the access cabinet. Furthermore, embodiments provided herein enable the insertion of elevator components wider than the visible face of the access cabinet. Moreover, in some configurations, no dimensional increase or change in modification of a building interface is required. Further, due to the ability to rotate and pivot the elevator components from a stowed state (FIG. 3A) to a deployed state (FIG. 3D), improved work area can be provided to mechanics and technicians. That is, there is no need for a mechanic to reach into a cabinet, but rather the mechanic can work and operate while standing on the landing with sufficient room to move and access all elevator components that are stored within the housing of the access cabinet.

As used herein, the use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity).

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

1. An elevator component access cabinet comprising:
a housing having an access door;
a sliding element contained within the housing; and
at least one elevator component pivotably mounted to the sliding element about a first pivot,
wherein the sliding element is movable between a first state and a second state, and wherein when in the first state, the at least one elevator component is stowed within the housing and in the second state the at least one elevator component is located outside of the housing, and the at least one elevator component is pivotable about the first pivot to enable access to the at least one elevator component.

2. The elevator component access cabinet of claim 1, wherein the housing has a length and a width, wherein the length is longer than the width.

3. The elevator component access cabinet of claim 2, wherein the length is at least twice as long as the width.

4. The elevator component access cabinet of claim 1, wherein the access door is pivotably mounted to the housing by a second pivot.

5. The elevator component access cabinet of claim 1, further comprising a lock arranged to secure the access door to the housing when the sliding element is in the first state.

6. The elevator component access cabinet of claim 1, wherein the at least one elevator component comprises at least one of an elevator control board, a fuse, a breaker, a plug, an inspection panel, a battery, a transformer, an electrical distribution panel, and wiring.

7. An elevator system comprising:
an elevator component access cabinet having a housing having an access door, a sliding element contained within the housing, and at least one elevator component pivotably mounted to the sliding element about a first pivot,
wherein the sliding element is movable between a first state and a second state, and wherein when in the first state, the at least one elevator component is stowed within the housing and in the second stale the at least one elevator component is located outside of the housing, and the at least one elevator component is pivotable about the first pivot to enable access to the at least one elevator component.

8. The elevator system of claim 7, wherein the elevator component access cabinet is part of an elevator door column.

9. The elevator system of claim 7, further comprising a landing having a landing door, wherein the elevator component access cabinet is located adjacent the landing door.

10. The elevator system of claim 7, wherein at least one of the housing and the access door are an aesthetic feature of the elevator system.

11. The elevator system of claim 7, wherein the housing has a length and a width, wherein the length is longer than the width.

12. The elevator system of claim 11, wherein the length is at least twice as long as the width.

13. The elevator system of claim 7, wherein the access door is pivotably mounted to the housing by a second pivot.

14. The elevator system of claim 7, further comprising a lock arranged to secure the access door to the housing when the sliding element is in the first state.

15. The elevator system of claim 7, wherein the at least one elevator component comprises at least one of an elevator control board, a fuse, a breaker, a plug, an inspection panel, a battery, a transformer, an electrical distribution panel, and wiring.

16. The elevator system of claim 8, further comprising a landing having a landing door, wherein the elevator component access cabinet is located adjacent the landing door.

17. The elevator system of claim 8, wherein at least one of the housing and the access door are an aesthetic feature of the elevator system.

18. The elevator component access cabinet of claim 2, wherein the access door is pivotably mounted to the housing by a second pivot.

19. The elevator component access cabinet of claim 2, further comprising a lock arranged to secure the access door to the housing when the sliding element is in the first state.

20. The elevator component access cabinet of claim 2, wherein the at least one elevator component comprises at least one of an elevator control board, a fuse, a breaker, a plug, an inspection panel, a battery, a transformer, an electrical distribution panel, and wiring.
